(19) United States
(12) Patent Application Publication
(10) Pub. No.: US 2013/0066967 A1
(43) Pub. Date: Mar. 14, 2013

(54) SYSTEM AND METHOD FOR DISCOVERING AND INTERACTING WITH COMMON CONNECTIONS

(71) Applicant: James Alexander, Mount Kisco, NY (US)

(72) Inventor: James Alexander, Mount Kisco, NY (US)

(73) Assignee: Vizibility Inc., New York, NY (US)

(21) Appl. No.: 13/436,755

(22) Filed: Mar. 30, 2012

Related U.S. Application Data
(60) Provisional application No. 61/533,549, filed on Sep. 12, 2011.

(51) Int. Cl. G06F 15/16

(52) U.S. Cl. 709/204

(57) ABSTRACT

Disclosed herein are systems, methods, and non-transitory computer-readable storage media for facilitating sharing and accessing social networking information between two users. A user can establish a profile for sharing with others, which contains pre-authorization to access and share certain social network information. The profile can be linked by a machine-readable code, such as a QR code, that encodes a network address, such as a URL, to the profile containing access to the pre-authorized social networking information. The user shares information quickly with another user by sharing the QR code. Another user scans the QR code with a smartphone or other camera enabled device, which navigates to the profile. After the other user logs into social networks on the device, the profile scans and/or compares both users' social networking profiles for commonalities, such as shared interests and connections. Then, the users can quickly determine common connections almost immediately.

### RELATED APPLICATIONS

This application relates to U.S. Non-Provisional patent application Ser. No. 12/847,077, filed 30 Jul. 2010. This application claims priority to U.S. Provisional Patent Application No. 61/533,549, filed 12 Sep. 2011, the content of which are herein incorporated by reference in their entirety.

### BACKGROUND

1. Technical Field

The present disclosure relates to social networking and more specifically to enabling access to commonly shared social network connections based on sharing access to pre-authorized data.

2. Introduction

Often individuals meet at networking events and share business cards, resumes, or other contact information. Later, after the networking event, the individuals connect on a social network and discover that they have shared acquaintances or other common information. Such information is a great way to strike up conversations, build credibility, enhance reputation or facilitate initial discussions, but the knowledge of the shared acquaintances often comes too late to benefit those initial encounters. Users can attempt to connect on the social network on the spot, but one or the other may not have a computing device, their battery may be dead, and even if they can connect on the social network, social protocol may prohibit or look down on lengthy interactions with a mobile phone or tablet during such networking events. Accordingly, what is needed in the art is a way to enhance initial social interactions or to rapidly discover common connections or other shared social networking data.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for quickly discovering commonly shared connections or other shared social network data. A system configured to practice the method receives, from a requesting device, a request referencing a network resource locator, the network resource locator referencing a profile for a first person, the profile including information about the first person, and maintained at a server, the server pre-authorized by the first person to access social network information about the first person from a social networking service, wherein the network resource locator is encoded in a machine readable mark, such as a Quick Response (QR) code, Microsoft TAG, 3D barcode, 2D barcode, or other mark that encodes information, which was decoded by the requesting device in order to determine the network resource locator and generate the request. The system then serves, to the requesting device, information from the profile of the first person, and social connection information concerning social connections, if any, between a second person, who has authenticated with one or more social networking services on the requesting device, and the first person, wherein the social connection information is obtained from the at least one of the one or more social networking services. After the second person has authenticated on one or more social networks shared by the first person, the second person may request to make a social networking connection to that person through the social networks in common between them. The system can notify the first person of the second person's actions to access their common connections through the disclosed system, including information about the second person, when and where the request was made.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example system for determining common connections between a requesting entity and another entity;

FIGS. 3, 3A, 3B, 3C, 3D, and 3E depict example account management pages;

FIG. 4 depicts an account intake process;

FIG. 5 depicts an example process for using a machine readable code in association with an example tangible article;

FIG. 6 depicts an example arrangement for accessing social network information from one or more service providers via an API;

FIG. 7 illustrates an example computing system;

FIG. 8 illustrates an example data flow between an example device and an example serving system;

FIG. 9 illustrates a first sample mobile user interface; and

FIG. 10 illustrates a second sample mobile user interface.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

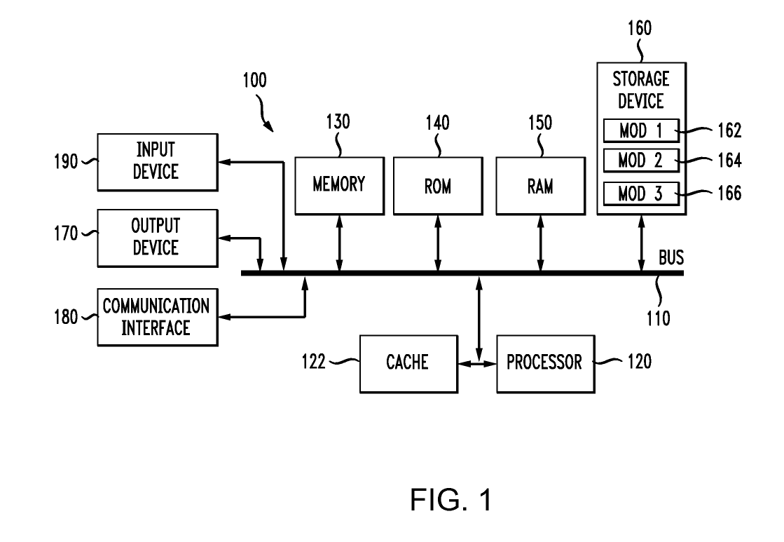

The present disclosure addresses the need in the art for enhancing availability of social networking information. A brief introductory description of a basic general purpose system or computing device in FIG. 1 which can be employed to practice the concepts is disclosed herein. A more detailed description of the exemplary approaches and sample infrastructure will then follow. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

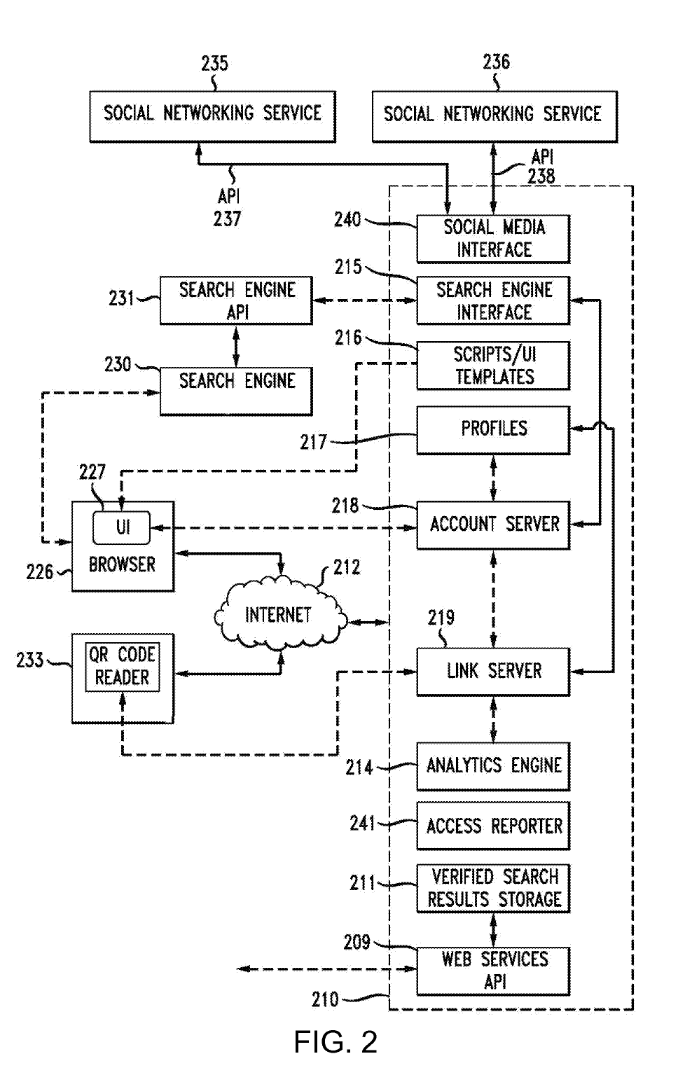

Having disclosed some components of a computing system, the disclosure now returns to a discussion of enhancing social networking interactions. FIG. 2 depicts an example system 210 in which common connections between a requesting entity and another entity can be determined. The system 210 can include a variety of functional components, such as a social media interface 240 and account server 218. The social media interface 240 can communicate with one or more social networking services 235, 236 via respective APIs 237, 238, for example. A search engine interface 215 can communicate with the search engine API 231 which is an interface to a search engine 230. A browser 226 can include UI 227 and communicates over Internet 212 system 210. The UI 227 can be controlled entirely or partially via local or server-based scripts or UI templates 216. A mobile device can include a decoder for machine readable marks such as a QR code reader 233. QR code reader can read a QR code that will include a URL, URI, or other form of network resource addressing, that points to a resource available through system 210 as explained below. The QR code reader 233 can point to a link server 219 which incorporates information from a profile database 217. As a user scans a QR code, for example, the link server 219 can report to an analytics engine 214. Further, an access reporter 241 can generate alerts, notifications, and/or log entries of which devices accessed the link at which times. The system can incorporate a verified search results storage 211. The system can provide a user-facing web services API 209 for configuration, administration, and/or other purposes.

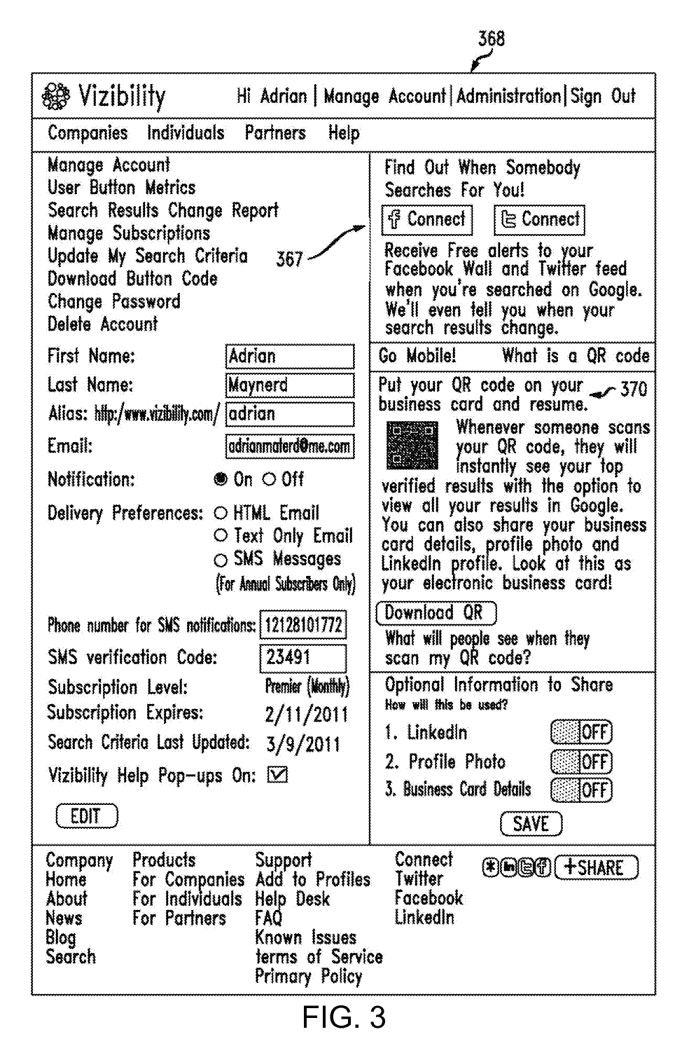

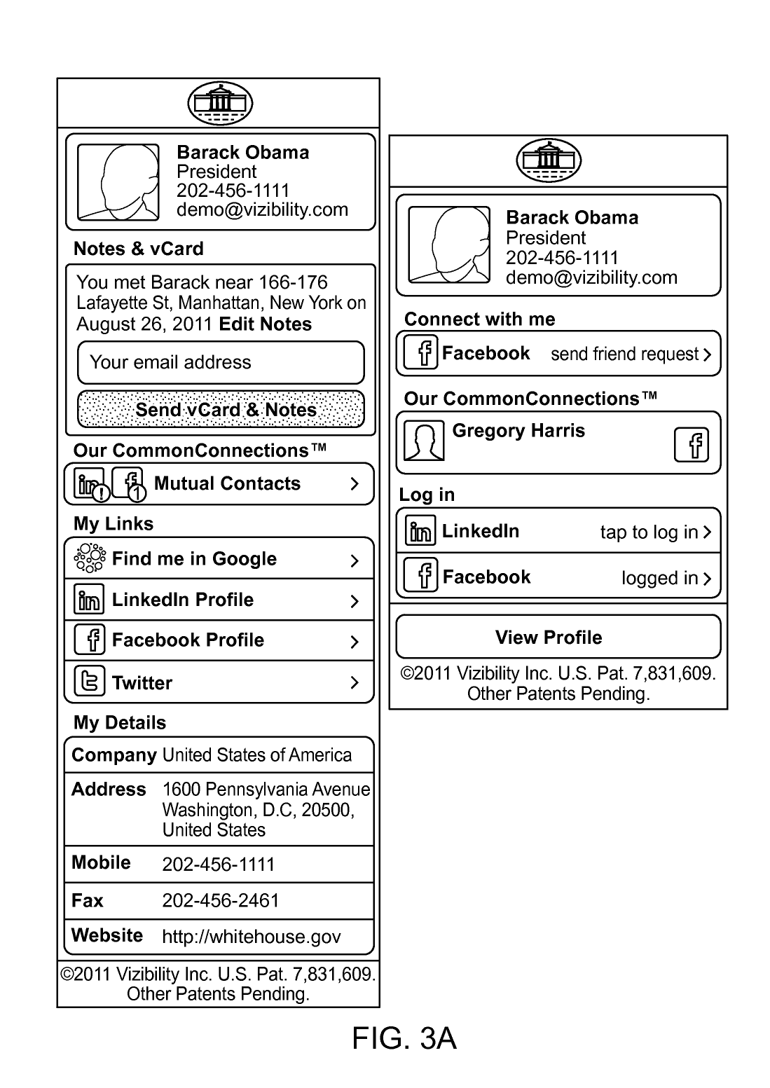

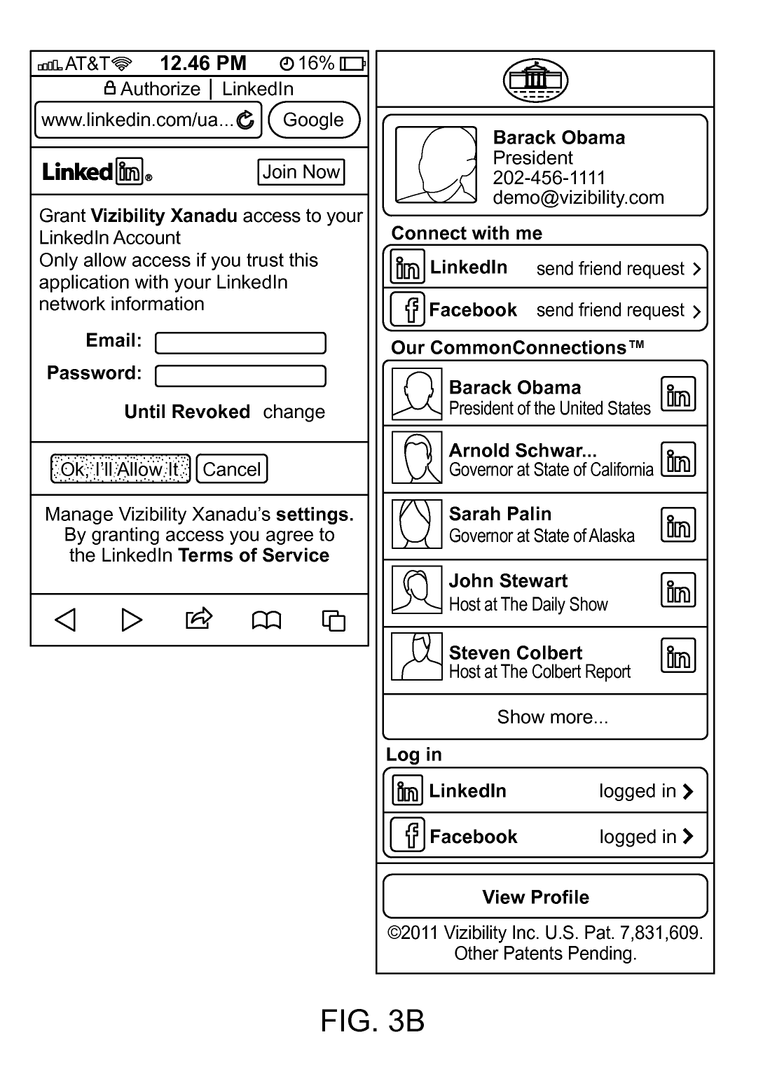

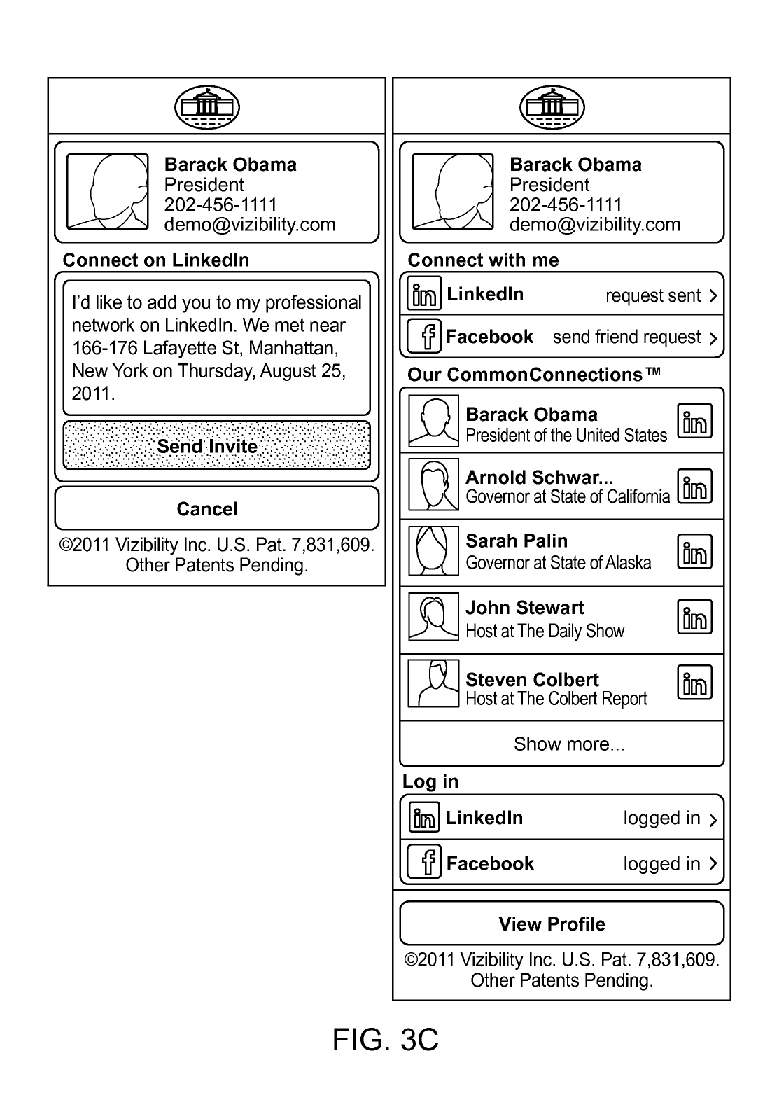

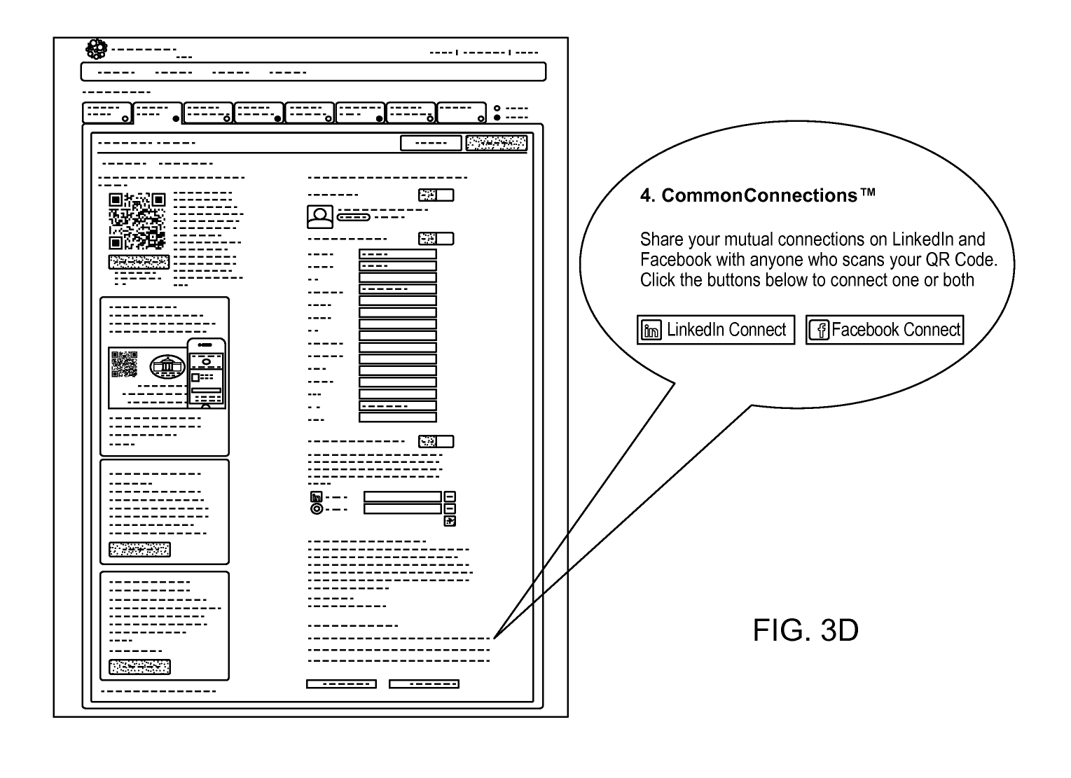

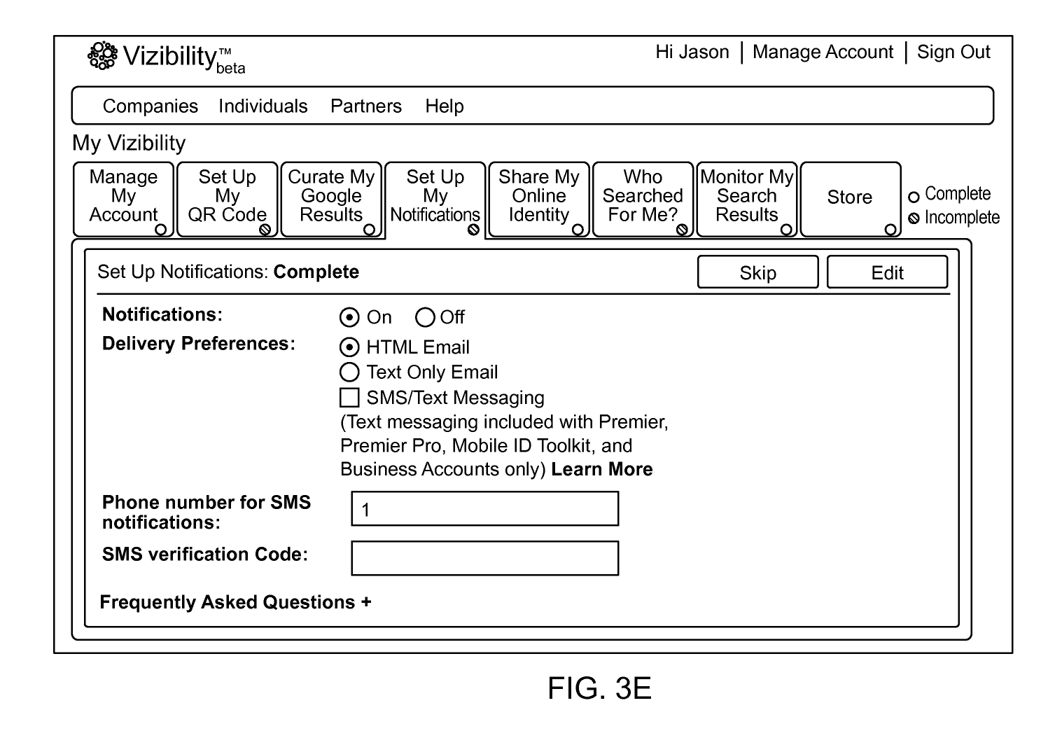

FIGS. 3 and 3A-3E depict example account management pages. FIG. 3 illustrates an example account setup page 368 in which a QR code 370 can be obtained as a preview, for example. The account setup page 368 can include options for dictating the type of machine readable code to present to the user, such as a QR code, a full URL, a shortened URL, an encoded string, a network address, and so forth. This page also provides a section 367 for pre-authorizing and connecting the account with a social network. The user can also indicate which sources of information to share with others, such as LinkedIn, Profile Photo, and Business Card Details.

In FIG. 3A, the searcher has already connected to Facebook and is being informed that he/she has one common connection with Barack Obama via Facebook. The searcher is also informed that he/she has not yet logged in to LinkedIn to see their common connections. When the searcher clicks on the Mutual Contacts button, the system displays the Common Connections page. This page informs the searcher who they have in common. The searcher can also send a friend request to the user via Facebook, for example.

In FIG. 3B, the searcher can log in to LinkedIn via a mobile optimized page or other interface that asks to connect and allow the system to fetch social graph information, such as a complete list of connections or a list of common connections, for example. This process can include one or more other social networks, as well. When the user connects to LinkedIn, the system shows all of the LinkedIn users in common between the searcher and the searchee (Barack Obama in this case). The searcher can also “send a friend request” to the searchee through the interface without navigating to the social network web site.

In FIG. 3C, if the searcher clicks “send a friend request” via LinkedIn, the system shows a mobile friendly (or other version) of LinkedIn's connect feature. The system pulls contextual information such as the date and location of the meeting to include with the invitation. This information can assist the recipient to remember when, how, and under what circumstances they met. After the searcher clicks “send invite” the system returns to the common connections page, where the status “send friend request” is updated to “request sent”.

In FIG. 3D, the common connections portion of the profile page allows the user to pre-authorize the sharing of mutual connections on a social network with anyone who scans a QR code or other machine readable mark or who navigates to the custom URL. FIG. 3E illustrates how to set up notifications to the searchee when a searcher scans their QR code or other machine readable mark.

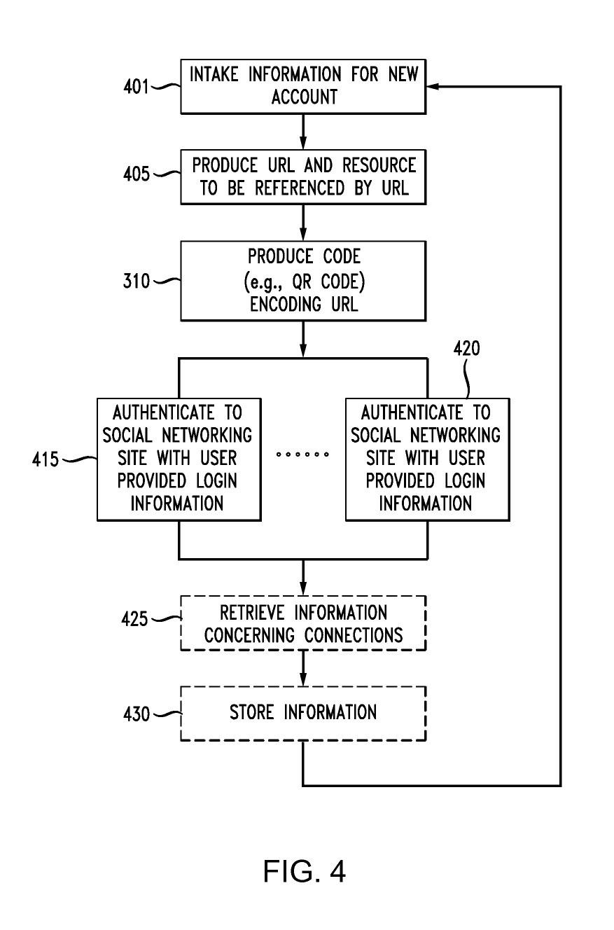

FIG. 4 depicts an account intake process. In particular the Intake process can include in taking information for new account 401. An interface for intaking such information is shown in FIG. 3. The process can include producing a URL and resource or resources to be referenced by that URL 405. Code for example QR code encoding the URL produced can be produced 410. Information gathered during Intake can include information about which social networks the user subscribes to or otherwise participates in the user can then authenticate through the system to allow the system to access the social network information of that user for each social networking site. Two example authentications 415 and 420 are shown. As quickly information concerning such social networking information can be retrieved 425 and stored 430. These steps are optional in that such information can be retrieved responsive to a particular request and not necessarily done during an account intake process. If the information is stored and not accessed in real-time then a periodic update procedure may be used.

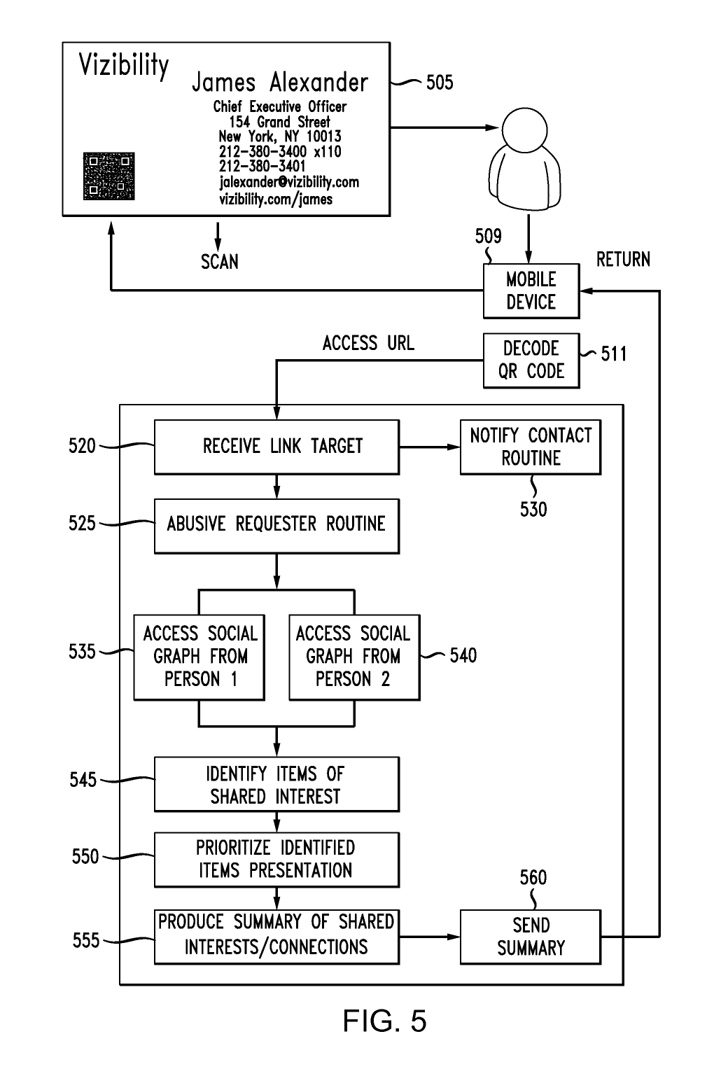

FIG. 5 depicts an example of a process of using a machine readable code as provided with respect to FIGS. 3 and 4. The example tangible article that can include such code is shown by business card 505. A mobile device 509 can scan and decode the code 511. A resource locator, such as the URL can be obtained from the decoded QR code that URL can be used to request the resource identified a system receives that quest 520 conducts interviews of requester between 525 and notification contact routine 530. Subsequently social graph information for person one can be accessed 535 as well as for person two. First one person to can be for example a person associated with business card scanned in person two can be a person associated or otherwise controlling mobile device 509. Items of interest can be identified 545 and prioritize for interest or which ones will be returned 550. A summary of such shared interest or connections can be produced 555 and sent 560.

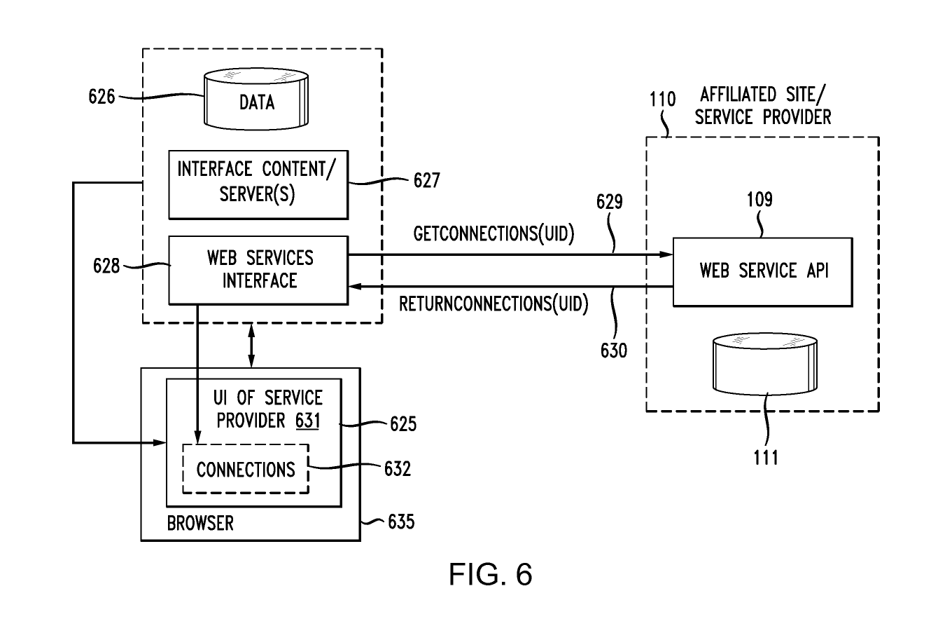

FIG. 6 depicts an example where an API can be used to access social network information from one or more service providers. This example service provider 610 can maintain a web service API 609 and data storage 611. Web service API maintains an ability to allow authorized requesters to access certain information about a particular identified user of service provider 610. By example and get connections API call 629 can be provided (the name is arbitrary, and can be selected by service provider 610 but would generally conform to the stated functions herein). Such an API call can identify a particular user of the system according to a unique number or other username on the system. In response such information can be returned 630 such data is manipulated and return through Web services interface 629 to a requesting device, as described previously.

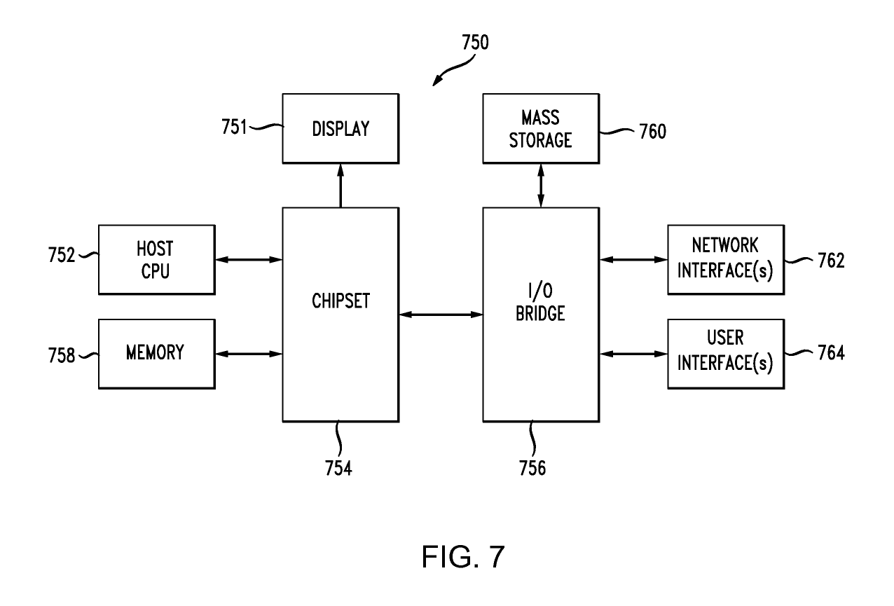

FIG. 7 depicts an example of a computer system 750 that can be used to implement described structural elements, such as the structural elements depicted in FIG. 1. By particular example, a computer system according to the example computer system 750 can be used in executing browsers, a number of such systems 750 can be employed at search engine 130, as well as at search query search query provider 110.

Example computer system 750 may include a host Central Processing Unit (CPU) (752), which may be implemented as a semiconductor containing one or more distinct microprocessor units, commonly called “cores”, to indicate distinctness, but yet integration on a common substrate. Modern processors typically comprise multiple cores, such as 2, 4, 6, 8, 12 or more cores. Host CPU 752 also can be implemented with a plurality of physically separate microprocessor units, disposed in separate sockets. Host CPU 752 communicates with a chipset 754, which typically includes memory bus logic, and other interfaces to other functionality, such as an expansion bus for supporting I/O, such as network traffic to and from network interface(s) 762, mass storage 760 (e.g., hard drives), as well as peripherals, such as those that can be provided for a user interface (764). Example of such peripherals include a keyboard, serial I/O, a mouse, voice recognition inputs, touch screen inputs, and so on.

Chipset 754 also may support connection of a display 751, and therefore may include graphics logic for rendering content to be displayed. Such graphics logic may use main memory 758 as video memory, or a separate video memory may be provided. Where system 750 is used for implementing end-user computers, a display 751 is more likely to be included. Frequently, if system 750 is functioning as a server, a display would not be provided.

Of course, the example system 750 is provided by way of example and not limitation as to what kinds of devices may be used in implementing aspects disclosed herein. Those of ordinary skill in the art may adapt the disclosures presented herein for use with a variety of devices, such as smartphones, tablet computers, laptops, and so on, which may be implemented using components that are more or less integrated than those depicted herein, and which may include more functionality or fewer functions than what is depicted in this example.

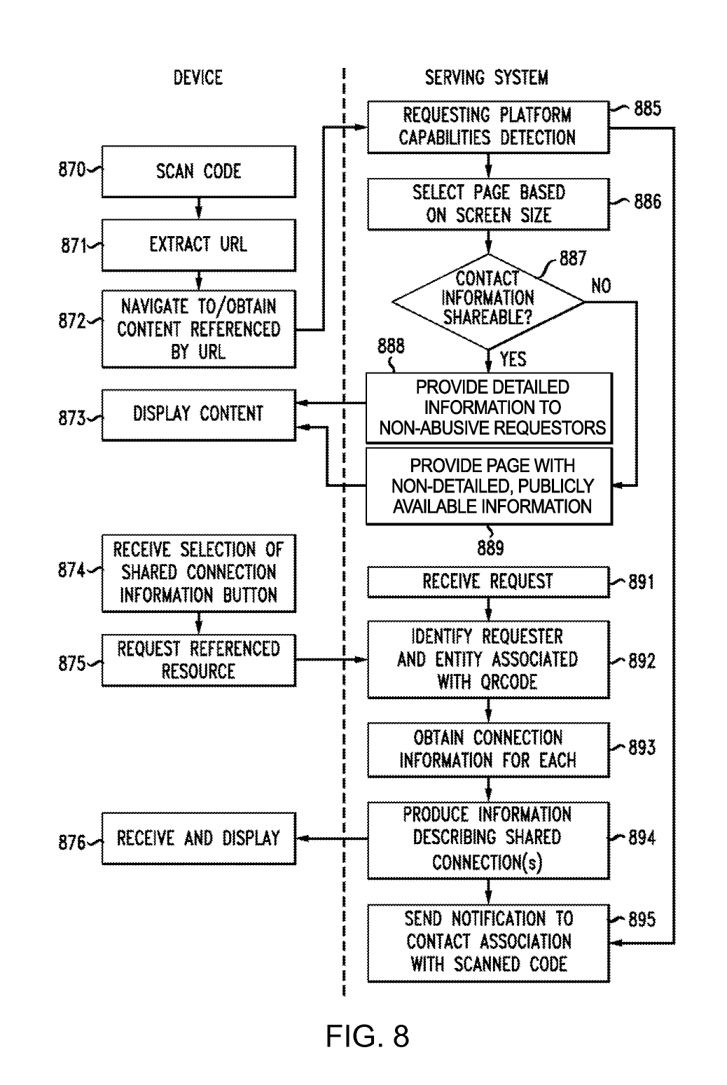

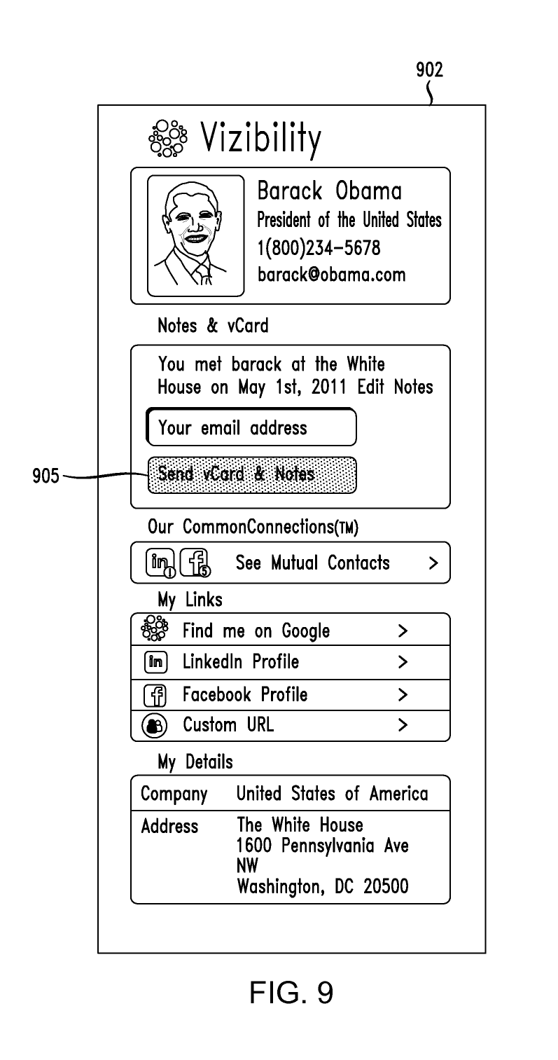

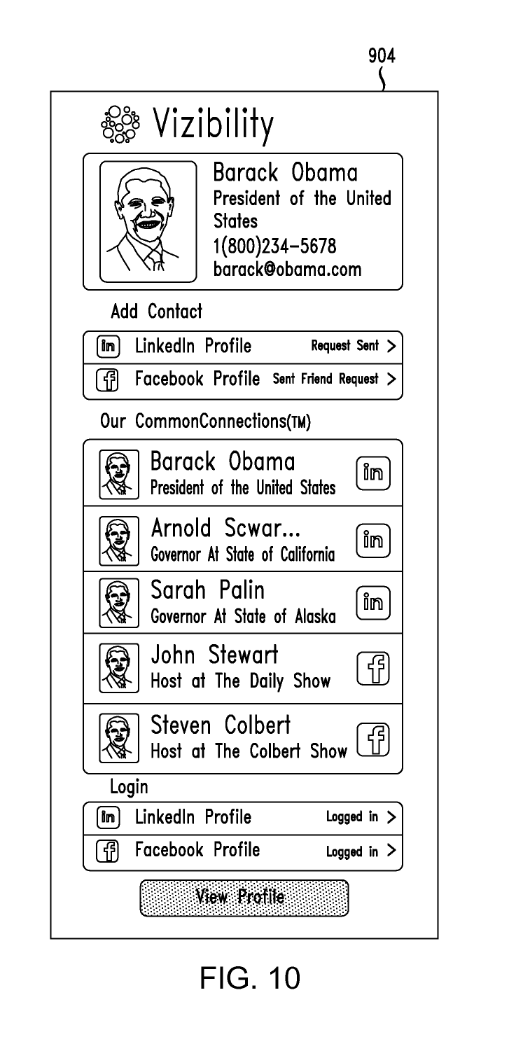

FIG. 8 depicts the data flow between the device and serving system the state of flow can for example be implemented by the system also five. Dataflow comprises a device scanning a code 870 and extracting a URL or other resource identifier there from 871. An appropriate web browser or other application on device navigates to or otherwise attempts to obtain content referenced by that URL 872 by requesting such information from the serving system serving system receives such request 885 and request platform capabilities identification. Were example for mobile device information such as screen resolution operating system can be detected responsibly a page size can be selected 886 determination as to whether contact information shareable 887 can be conducted. In one example such determination can include determining whether the requester is abusive or not, as described above. If the contact information is not shareable, such as for example because requester is abusive then non-detailed, publicly available information such as a page of search results can be provided 889. However if the context information is shareable, then the system can provide a page that includes other information such as profile examples of such information can be provided or other detailed information for non-abusive requestors 888 for example FIGS. 9 and 10 to be described below in any event information will be returned and displayed by the device 873. Subsequently interaction by user with the display interface can include receiving a selection of shared connection information button 874 responsibly request for such information can be generated 875 received 891.

As will be described below to serve such information if a user of the device is not already locked into one or more social networks then a capability to log in to such social networks will be provided. By logging in to such networks through device and by following the link presented in FIG. 8 the application can access or otherwise use an API provided by the service provider to obtain information of interest. Thus both a requesting person and an entity associated with the machine code are identified 892. Thus when a request is made request can be made through a particular user account such as a user account associated with the person using the device and the user identified can be the user identified by the decoded code from the QR code. The API can return specific connection information for the combination of the particular user of the device and the requested identified party. Other processing of such information can be done 894 after which a notification procedure can be conducted 895.

FIG. 9 depicts an example of a private profile 902 that is returned responsive to determining that a request for a particular profile was received from a non-abusive requester. As can be understood such profile includes the capability to receive information concerning shared connections are mutual contacts however shared information is not limited to contacts and can include any common information between the parties such as school affiliations, hobbies, work history, and/or any other category of content maintained by the given social network. By selecting this, a user is provided a capability to log into one or more social networks such as LinkedIn and Facebook 905. When the user is already logged into LinkedIn, Facebook, or other social network, the system can show information including common connections 904. Further the capability is provided to add contacts in the social networks. Screenshot 904 depicts connections between the requesting user/device and the person identified by the resource locator encoded in the QR code, based on a pre-authorized connection or authorization to access at least part of the information in the person's social networking information.

Other information depicted in screenshots 902, 904 includes location information that can be associated or otherwise provided with the profile depiction. For example information about where and when the user of the device met user identified by the resource locator can be shown.

Having disclosed some basic system components and concepts, the disclosure now turns to the exemplary method embodiments. For the sake of clarity, the methods are discussed in terms of an exemplary system 100 as shown in FIG. 1 configured to practice the method. The steps outlined herein are exemplary and can be implemented in any combination thereof, including combinations that exclude, add, or modify certain steps.

In one embodiment, the system 100 receives, from a requesting device, a request referencing a network resource locator, the network resource locator referencing a profile for a first person. The profile can include information about the first person. A server can maintain the profile. The first person can authorize the server to access social network information about the first person from a social networking service. The network resource locator can be encoded in a machine readable mark, such as a QR code, barcode, shortened URL, and so forth, which was decoded by the requesting device in order to determine the network resource locator and generate the request.

The system 100 serves, to the requesting device, information from the profile of the first person, and social connection information concerning at least one social connection between a second person, if one exists, who has authenticated with the social networking service on the requesting device, and the first person, wherein the social connection information is obtained from the at least one of the one or more social networking services.

If the second person has not authenticated with the social networking service, the system 100 can present an authentication interface to the second person. The information from the profile of the first person is served as part of a web page having at least one of profile information and a link to authenticate with the social networking service, wherein after authenticating the link, the web page further includes common connection information based on information obtained from the social networking service. If the requesting device is abusive, the system 100 can further alter how the information from the profile of the first person is served.

The system 100 can determine if the requesting device is unabusive, such as a legitimate person scanning a QR code as opposed to a spider, searchbot, a request that is part of a denial of service attack, or other web crawler. Then the system 100 serves information from the profile of the first person only if the requesting device is determined to be unabusive. The social connection information can be identified within the social networking service itself; however a third party server and/or a user client device can also identify common social networking information.

In a second embodiment, the system 100 receives a request at a server, over a network, for a first resource identified by a network resource identifier, the network resource identifier being encoded in a machine readable graphical code assigned to a first entity and associated with the first entity by machine readable data stored in a tangible computer readable medium. Responsive to receiving the request, the system 100 obtains social connection information for the first entity from a third-party. The system 100 correlates a source of the request to a second entity identifier, and retrieves information representing social graph information for each of the first entity and the second entity. The system 100 identifies one or more items of social graph information in common between the first entity and the second entity, and sends the identified one or more items of social graph information to the source of the request.

The network resource identifier can be a domain-reference portion that references a domain, and other resources on the domain do not include links to the network resource identifier encoded in the machine readable graphical code. The network resource identifier can be a URL or other network address mechanism, and the machine readable graphical code can be a QR code or any other type of machine readable code. The resource can include profile information for the first entity. The system 100 can further notify the first entity of the request. Retrieving information representing social graph information for each of the first entity and the second entity can include accessing social graph information through an API provided by one or more social networking services. Identifying one or more items of social graph information in common between the first entity and the second entity can include identifying a person associated with both the first entity and the second entity, and the sending can include sending identifying information of the person. Identifying one or more items of social graph information in common between the first entity and the second entity can include identifying a shared previous or current employer.

The system 100 can identify one or more items of social graph information in common between the first entity and the second entity by identifying a shared interest between the first entity and the second entity. The system 100 can identify one or more items of social graph information in common between the first entity and the second entity by identifying a shared group. Identifying one or more items of social graph information in common between the first entity and the second entity can include identifying a shared hobby, educational background, etc. The request can be generated by a mobile device optically scanning and decoding the Quick Response (QR) code. The mobile device can be controlled by the second entity.

In a third embodiment, the system 100 receives a request comprising an identifier at a server, the request generated by a device. The system 100 matches the identifier to an entity. The system 100 provides an interface for display on the device. The interface can include a button that allows a user of the device to login to one or more social network services, if not already logged in on the device, the option activating an API call to one or more such services, the API call comprising information identifying the entity. The system 100 receives an item of information comprising information about one or more connections or interests shared between the entity and the user of the device, and provides that item of information for display on the mobile device.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A method comprising:
receiving, from a requesting device associated with a requestor, a request referencing a network address associated with a profile for a target user,
wherein the profile comprises information about the target user,
wherein the profile is maintained at a server pre-authorized by the target user to access social network information about the target user from a social networking service, and
wherein the network address is encoded in a machine readable mark from which the requesting device extracted the network address; and
serving, to the requesting device, an indication of mutual contacts between the target user and the requestor based on the social network information, wherein the indication is presented via a graphical user interface that displays a number of mutual contacts from the social networking service between the target user and the requestor.

2. The method of claim 1, further comprising:
if the requestor has not authenticated with the social networking service, presenting an authentication interface to the requestor.

3. The method of claim 1, wherein the indication is served as part of a graphical user interface having at least one of profile information and a link to authenticate with the social networking service, wherein after authenticating the link, the graphical user interface further comprises common connection information based on information obtained from the social networking service.

4. A system comprising:
a processor; and
a memory storing instructions for controlling the processor to perform steps comprising:
receiving, from a requesting device associated with a requestor, a request referencing a network address associated with a profile for a target user,
wherein the profile comprises information-about the target user,
wherein the profile is maintained at a server pre-authorized by the target user to access social network information about the target user from a social networking service, and
wherein the network address is encoded in a machine readable mark from which the requesting device extracted the network address; and
serving, to the requesting device, an indication of mutual contacts between the target user and the requestor based on the social network information.

5. A non-transitory computer-readable storage medium storing instructions which, when executed by a computing device, cause the computing device to perform steps comprising:
receiving, from a requesting device associated with a requestor, a request referencing a network address associated with a profile for a target user,
wherein the profile comprises information about the target user,
wherein the profile is maintained at a server pre-authorized by the target user to access social network information about the target user from a social networking service, and
wherein the network address is encoded in a machine readable mark from which the requesting device extracted the network address; and
serving, to the requesting device, an indication of mutual contacts between the target user and the requestor based on the social network information, wherein the indication is presented via a graphical user interface that displays a first number of mutual contacts from a first social network and a second number of mutual contacts from a second social network.

6. The method of claim 1, further comprising: determining the mutual contacts between the target user and the requestor by comparing a social graph information associated with the requestor and the target user.

7. The method of claim 1, wherein the server is pre-authorized to access social network information on behalf of any user who scans the machine readable mark.

8. The method of claim 1, wherein the graphical user interface further displays a list of common interests between the target user and the requestor.

9. The method of claim 1, wherein the machine readable mark comprises a quick response code on a business card.

10. The method of claim 1, further comprising determining that the requestor is unabusive.
